(19) United States
(12) Patent Application Publication
(10) Pub. No.: US 2026/0245020 A1
(43) Pub. Date: Aug. 20, 2026

(54) METHOD FOR GRADING SUITABLE CONSTRUCTION RANGE BASED ON COLD ISLAND VALUE EVALUATION

(71) Applicant: ARCHITECS & ENGINEERS CO., LTD. OF SOUTHEAST UNIVERSITY, Jiangsu (CN)

(72) Inventors: Hua LIU, Jiangsu (CN); Xin ZHOU, Jiangsu (CN); Dongqing HAN, Jiangsu (CN); Ying TANG, Jiangsu (CN); Xiaohan SHEN, Jiangsu (CN); Xing SHI, Jiangsu (CN); Xin GE, Jiangsu (CN); Weiren ZHUANG, Jiangsu (CN)

(73) Assignee: ARCHITECS & ENGINEERS CO., LTD. OF SOUTHEAST UNIVERSITY, Jiangsu (CN)

(21) Appl. No.: 18/834,230

(22) PCT Filed: Dec. 21, 2023
(86) PCT No.: PCT/CN2023/140582

§ 371 Date: Sep. 18, 2025

(30) Foreign Application Priority Data
Mar. 20, 2023 (CN) 202310286119.9

(51) Int. Cl. G06Q 10/0637; G06Q 50/08

(52) U.S. Cl. CPC G06Q 10/0637; G06Q 50/08

(57) ABSTRACT

The present disclosure discloses a method for grading a suitable construction range based on a cold island value evaluation, comprising: acquiring the relevant data for the natural ecological elements within a research range, and determining a rigid protection range; summarizing a rigid protection range chart library, and superposing all rigid protection range charts based on a GIS platform to obtain a basic suitable construction range chart; acquiring vegetation patches and water body patches located outside the rigid protection range based on ENVI and AutoCAD platforms; performing a cold island value evaluation on the vegetation and water body patches located outside the rigid protection range based on the ENVI platform to obtain a cold island value grading chart; further grading the basic suitable construction range chart to obtain a suitable construction range grading chart; and applying the suitable construction range grading chart in a planning and designing.

### TECHNICAL FIELD

The present disclosure relates to the technical filed of the urban design, and specifically relates to a method for grading a suitable construction range based on a cold island value evaluation.

### BACKGROUND

Under the concept of the sustainable development, the research and the evaluation on the “construction suitability” of the urban land is an important starting point for prompting the harmonious coexistence between the artificial and the natural environments. The urban design commonly takes the basic suitable construction range as the basis of the layout for the urban construction land. For the hot-summer and cold-winter climate zone, it is of great significance to form the energy-saving urban with an excellent atmospheric thermal environment by introducing the thermal and humidity environment analysis technology into the suitable construction analysis process to exploring the urban cooling ways.

Currently, the analysis of the suitable construction related to the protection of the natural ecological elements in China generally focuses on the “rigid” protection range proposed by the statutory plan, such as the ecological management control regions at all levels, the graded reservoirs or river courses. The spatial superposition of these protection ranges indicates the “unsuitable construction range” in the research range, and the remaining part is the “suitable construction range”. This basic suitable construction range provides a preliminary basis for the selection of the construction land. However, there are commonly a large number of natural ecological elements such as vegetation and water bodies in the suitable construction range. It is still a lack of the rational discrimination criteria for the protection and the utilization of these natural ecological elements. At present, the thermal and humidity environment analysis can identify the urban cold island through the technologies such as the satellite remote sensing, the land surface temperature inversion, and the microclimate environment simulation, so as to identify the possible value contributions of the vegetation and the water systems in the site to the urban cooling, which will assist the judgment the preservation significance of the natural ecological elements outside the rigid protection range in the construction suitability analysis process and avoid merely relying on the subjective selection of the designer.

In view of this, it is indeed necessary for the research range with rich natural ecological resources in the hot-summer and cold-winter climate zone to utilize the thermal and humidity environment analysis technology to explore the value evaluation method of the cold island to form the grading chart of the suitable construction range, which provides more accurate and reasonable judgment basis for the construction layout. Therefore, in the process of design and construction implementation, the goal of cold islands reservation, summer energy consumption reduction, sustainable development and ecological protection can be effectively realized.

### SUMMARY

The objectives of the present disclosure are to provide a method for grading a suitable construction range based on an evaluation for a cold island value. This method evaluates the cold island value for the vegetation and the water bodies outside the rigid protection range by using the AutoCAD platform, the ArcGIS platform and the ENVI platform, and grades the basic suitable construction range, which makes up for the accuracy of the current basic suitable construction range from the perspective of the physical environment. Therefore, in the process of design and construction implementation, the goal of cold islands reservation, summer energy consumption reduction, sustainable development and ecological protection can be effectively realized.

In order to achieve the above objectives, the following technical solutions are adopted in the present disclosure.

Provided is a method for grading a suitable construction range based on a cold island value evaluation. The method comprises following steps.

In Step 1, relevant data for natural ecological elements within a research range are acquired, and a rigid protection range is determined.

In Step 2, a rigid protection range chart library is summarized, and all rigid protection range charts are superposed based on a GIS to obtain a basic suitable construction range chart.

In Step 3, vegetation patches and water body patches located outside the rigid protection range are acquired based on an ENVI platform and an AutoCAD platform.

In Step 4, the cold island value evaluation is performed on the vegetation patches and the water body patches located outside the rigid protection range based on the ENVI platform to obtain a cold island value grading chart.

In Step 5, the basic suitable construction range chart obtained in Step 2 is further graded according to the cold island value grading chart to obtain a suitable construction range grading chart including a first-level suitable construction range, a second-level suitable construction range and a third-level suitable construction range.

In Step 6, the suitable construction range grading chart is applied in a planning and designing, a construction land with a floor area ratio greater than 0.8 is preferentially allocated within the first-level suitable construction range, when a total amount of the construction land in the first-level suitable construction range is insufficient, then the construction land with the floor area ratio greater than 0.8 is selected to be allocated within the second-level suitable construction range, and when a total amount of the construction land in the second-level suitable construction range is still insufficient, then the construction land with the floor area ratio greater than 0.8 is selected to be allocated within the third-level suitable construction range.

In Step 1, the relevant data for the natural ecological elements are AutoCAD vector terrain files, satellite image files and statutory planning documents in the research range.

In Step 1, the rigid protection range is a protection content explicitly stated in the statutory planning documents, including ecological management control regions at all levels, and graded reservoirs or river courses.

Step 2 includes specifically as follows. An image process is performed on data for the rigid protection range through GIS platform to summarize and obtain the rigid protection range chart library, and an area surrounded by clear closed boundary lines is displayed, and all rigid protection rang charts are superposed to form an unsuitable construction range. Remaining parts within the research range is the suitable construction range, forming the basic suitable construction range chart.

Step 3 specifically includes following sub-steps.

31. a Landsat8 satellite image corresponding to a research city is acquired, a LST file of a land surface temperature and a normalized difference vegetation index are obtained to generate a land surface temperature image.

32. a region with a value for the normalized difference vegetation index in a remote sensing image processing platform software of ENVI is selected to obtain the vegetation patches, a value for the normalized difference vegetation index ranges from 0.48 to 1. The water body patches are obtained according to the relevant data for the natural ecological elements. The vegetation patches and the water body patches are interested with the basic suitable construction range in Step 2 respectively to form the vegetation patches and the water body patches located outside the rigid protection range.

Step S4 specifically includes following sub-steps.

41. the vegetation patches and the water body patches located outside the rigid protection range are superposed on the land surface temperature image, the land surface temperatures at the patch boundaries and the land surface temperatures in the regions within 600 m from the patch boundaries are extracted, a line is drawn outward every 30 m with the patch boundary as a center, an average temperature of each of the lines is calculated and a broken line graph of temperature various is drawn, a breakpoint in the broken line graph with a slop closet to 0 and closet to the patch boundary is set as an acting range breakpoint, and a line where the breakpoint is located is a slow-heating range patch of the vegetation and a slow-heating range patch of the water body.

42. the land surface temperatures at all slow-heating range patch boundaries within a region are extracted based on the land surface temperature image in Step 3, and an average temperature of a corresponding slow-heating range patch is calculated and obtained. The average temperature of the slow-heating range patch boundary is taken as a temperature distinguishing the cold island and the heat island, so that a distribution chart of the cold and heat island ranges in the region is obtained.

43. land surface temperatures in vegetation and water body cold island ranges are extracted based on the land surface temperature image in Step 3.

44. an average land surface temperature in each of the water body cold island ranges is calculated based on the land surface temperature within the water body cold island range. A k-means clustering is performed by utilizing an Euclidean distance measurement formula according to an area of the water body cold island range and the average land surface temperature of the water body cold island range, and a clustering result is set into three categories, and the water body cold island is divided into three value regions of a low value region, a medium value region and a high value region on a basis of a value for the average land surface temperature in the region in each of the categories.

45. the vegetation in cold island is divided into three value regions of a high value region, a medium value region and a low value region correspondingly by utilizing a mean-standard deviation grading method based on the land surface temperature in the vegetation cold island range, and T denotes the average land surface temperature in the region.

| Category | Grading Method |
|---|---|
| Mean temperature | μ |
| Standard deviation of temperature | std |
| variation | |
| High value region | T < μ −2std |
| Medium value region | μ −2std ≤ T ≤ μ +2std |
| Low value region | T > μ +2std |

46. a first-level cold island range and a second-level cold island range are divided according to the cold island value evaluations of the vegetation and water body to obtain a cold island value grading chart.

The first-level cold island range is a superposition of the water bodies and the vegetation included in the high value region, and the second-level cold island range is a superposition of the water bodies and the vegetation included in the medium value region.

Step 5 includes specifically as follows.

The cold island value grading chart obtained in Step 4 is superposed on the basic suitable construction range chart obtained in Step 2, the basic suitable construction range is further decomposed into a first-level suitable construction range, a second-level suitable construction range and a third-level suitable construction range after processing by the GIS platform to obtain the suitable construction grading chart.

The first-level suitable construction range is a difference set between the basic suitable construction range and the first-level and the second-level cold island ranges.

The second-level suitable construction range is an intersection between the basic suitable construction range and the second-level cold island range.

The third-level suitable construction range is an intersection between the basic suitable construction range and the first-level cold island range.

The suitable construction range grading chart described in Step 5 is a vector file which is utilized as a basis of a layout for a development and construction land or utilized to enter a planning and control program.

### Beneficial Effect

(1) The present disclosure studies the coupling relation between the regional climate data and the urban space, and develops a method for grading the suitable construction range based on the cold island value evaluation for the hot-summer and cold-winter climate zone to guide the construction region to achieve the objectives of protecting the natural cold island, reducing the summer energy consumption, and reducing the urban energy conservation emission.

(2) The present disclosure utilizes the ENVI platform to propose a cold island value evaluation method in the hot-summer and cold-winter climate zone, implementing and forming an effective value determination method for the vegetation and the water body elements that have not been clearly reserved by the statutory plan.

(3) The present disclosure performs the refined grading on the basic suitable construction range, which avoids reducing the effect of regional cold island due to the destruction of the vegetation and water system with high value cold island, or losing the suitable land resource for the construction due to the preservation of the vegetation and water system when selecting the construction land layout subjectively merely based on the basic suitable construction range.

(4) The suitable construction range after refined grading based on the cold island value evaluation can directly serve as the basis for the layout, and the vector feature of the grading chart enables the present disclosure to enter the planning regulation program.

(5) The present disclosure is suitable for a large quantity of the undeveloped regions containing the vegetation and the water bodies that have not been clearly reserved by the statutory planning in the hot-summer and cold-winter climate zone, which has strong practicability and wide adaptability.

### BRIEF DESCRIPTION OF THE DRAWINGS

FIG. 1 illustrates a flow chart of a method in the present disclosure.

FIG. 2 illustrates a rigid protection range chart library.

FIG. 3 illustrates a basic suitable construction range chart.

FIG. 4 illustrates charts of the vegetation and the water body patches located outside the rigid protection range.

FIG. 5 illustrates a technology roadmap of the cold island value evaluation.

FIG. 6 illustrates a cold island value grading chart.

FIG. 7 illustrates a suitable construction range grading chart.

FIG. 8 illustrates a layout of a development and construction land after applying the suitable construction range grading chart.

### DETAILED DESCRIPTION OF THE EMBODIMENTS

The present disclosure is further described below with reference to a certain planning and construction area of 22 square kilometers in hilly land of the south of the Yangtze River, and the accompanying drawings of the method for grading the suitable construction range based on the cold island value evaluation.

According to the characteristic of the outdoor temperature and the thermal design requirements of different regions, China is divided into five construction thermal performance climatic regions by the “Thermal Design Code For Civil Building”, and the hot-summer and cold-winter region is one of the five construction thermal performance climatic regions, which is concentrated in the latitudes from 30° to 40°. Most cities in the intermediate and lower reaches of the Yangtze River region belongs to this climate region. Since the comfortable thermal environment of this region can not completely reply on the air conditioning, it mainly depends on the scientific strategies of the urban planning and the architectural design.

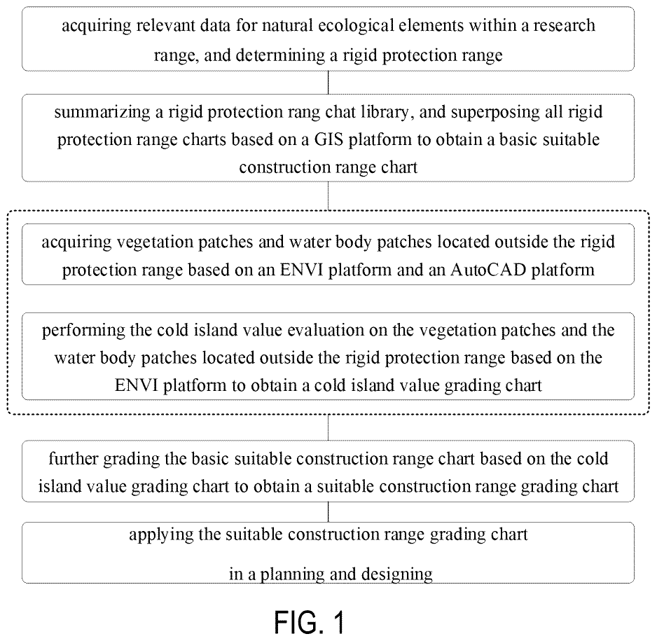

A flow chart of a method is as illustrated in FIG. 1, the present disclosure includes the following steps.

A, the relevant data for the natural ecological elements within a research range are acquired, and the data include the AutoCAD vector topographic files, the satellite image files and the statutory planning documents in the research range.

A rigid protection range is determined. The rigid protection range includes the reservoir, the planned river course, the suburban green land, the basic farmland, other non-construction land, the ecological protection range at national level, the ecological management and control region, the vegetation and the water body.

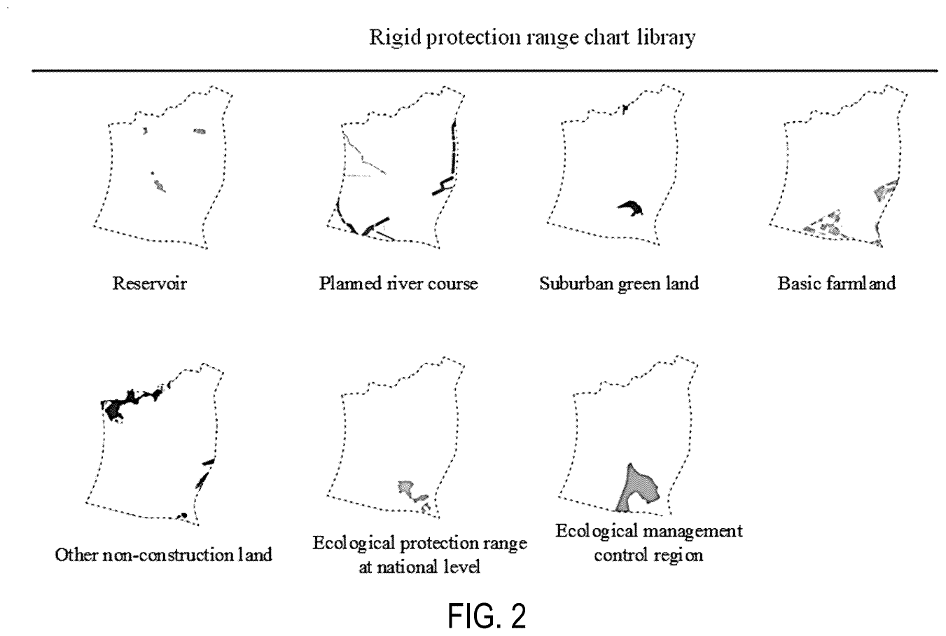

B, as illustrated in FIG. 2, the data are processed based on the geographic information system (GIS) platform to obtain the rigid protection range chart library, which is specially as follows.

The reservoir is the water surface surrounded by the shoreline of the normal water storage level formed by the artificial interception, and the E12 land in the planning document is extracted.

The planned river course is the water region enclosed by the upper edge line of the river course in the blue line planning control chart of the river course, and the E1 land (excluding the E12 land) in the planning document is extracted.

The suburban green land is commonly an area with better vegetation coverage, better landscape and landform, or an area that should be renovated, and the Eg land in the planning document is extracted.

The basic farmland commonly refers to the permanent basic farmland, which is cultivated land that cannot be occupied determined according to the overall land use plan, and the E2 land in the planning document is extracted.

The E land (excluding the reservoir, the planned river course, the suburban green land and the basic farmland) in the planning document is extracted as other non-construction land.

The ecological protection range at national level refers to the region included in the ecological function guarantee baseline in the ecological protection red line, prohibiting the industrialization and urbanization development, and the region enclosed by the vector lines of the ecological red line in the planning document is extracted.

The ecological management and control region is the natural region of the land and the marine located outside the ecological protection red line, which requires to retain their original appearance, strengthen the ecological conservation and the ecological construction, and restrict the development and construction, and the region enclosed by the vector lines of the ecological management and control region in the planning document is extracted.

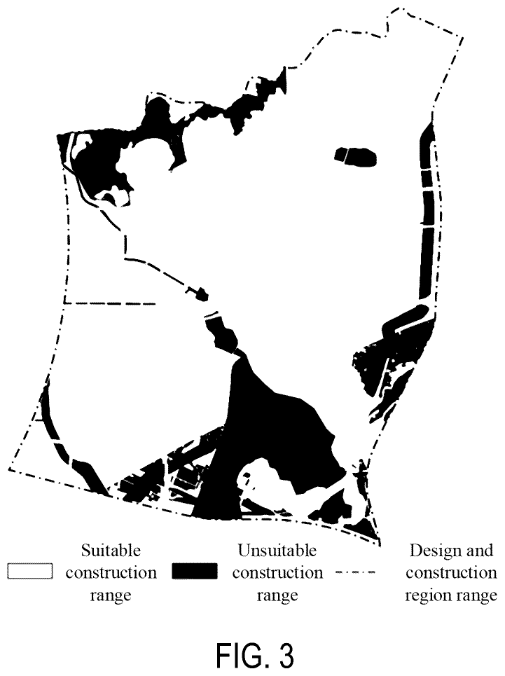

All the rigid protection range charts are superimposed based on the GIS platform, so that the design range lines of each of the charts are overlapped in the same proportion on the same plane, and the unsuitable construction range is formed after the superposition, and the remaining part in the research range is the suitable construction range, and the basic suitable construction range chart is generated, which is as illustrated in FIG. 3.

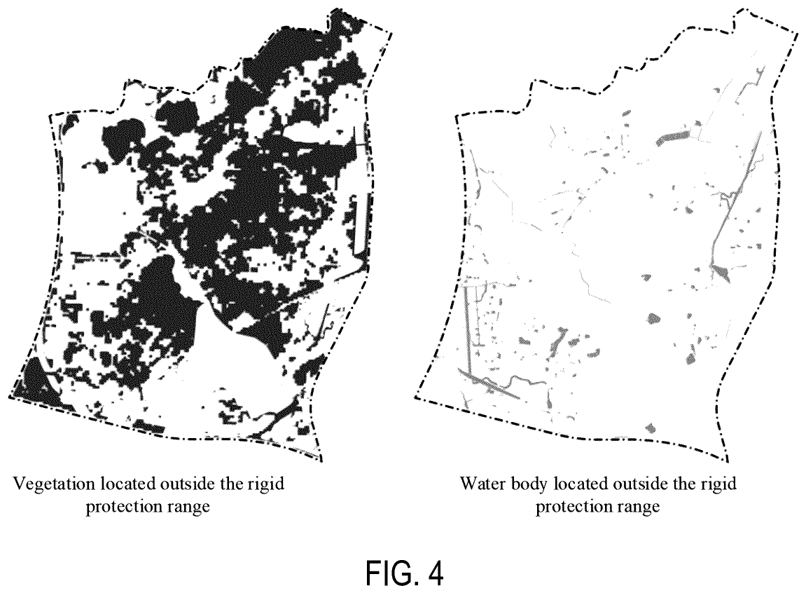

C, as illustrated in FIG. 4, the vegetation patches and the water body patches located outside the rigid protection range are acquired based on the environment for visualizing images (ENVI) platform and the AutoCAD platform, which is specifically as follows.

C1, the metadata file (MLT) in the Landsat satellite image file is opened, and the multiplication coefficient of 3.3420E-04 and the addition coefficient of 0.1 for a band 10 is obtained. The atmospheric transmittance of 0.62, the atmospheric upward radiance of 3.21 and the atmospheric downward radiance of 4.89 are obtained by utilizing the NASA standard near-infrared atmospheric correction algorithm, and the land surface temperatures in the band4, band5, band10 in the Landsat8 satellite image are calculated by utilizing the lst8 code, and the land surface temperature (LST) file and the normalized difference vegetation index (NDVI) are obtained to import into the ArcGIS to generate the land surface temperature image.

C2, the region of the value for NDVI greater than 0.48 in the ENVI is selected to obtain the vegetation patches. The water body patches are obtained according to the CAD terrain file. The vegetation patches and the water body patches located outside the rigid protection range are formed by taking an intersection of the vegetation patches and the water body patches with the basic suitable construction range described in Step C respectively.

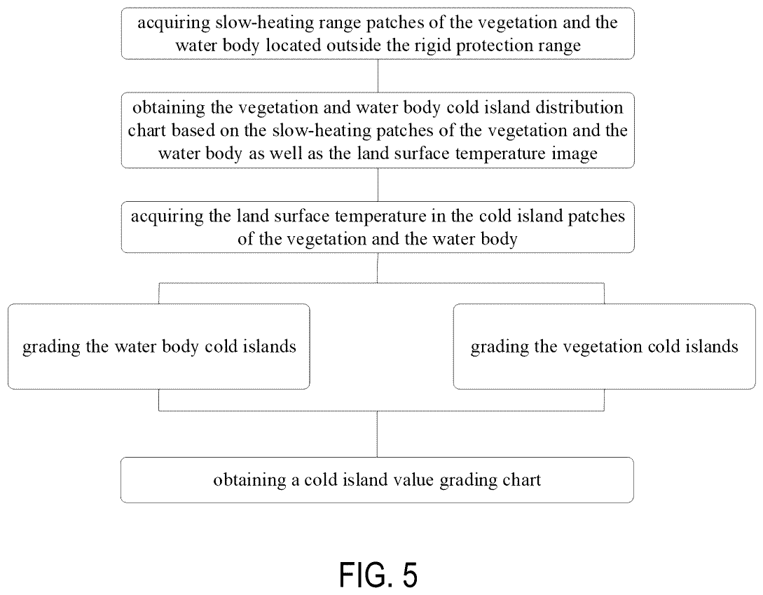

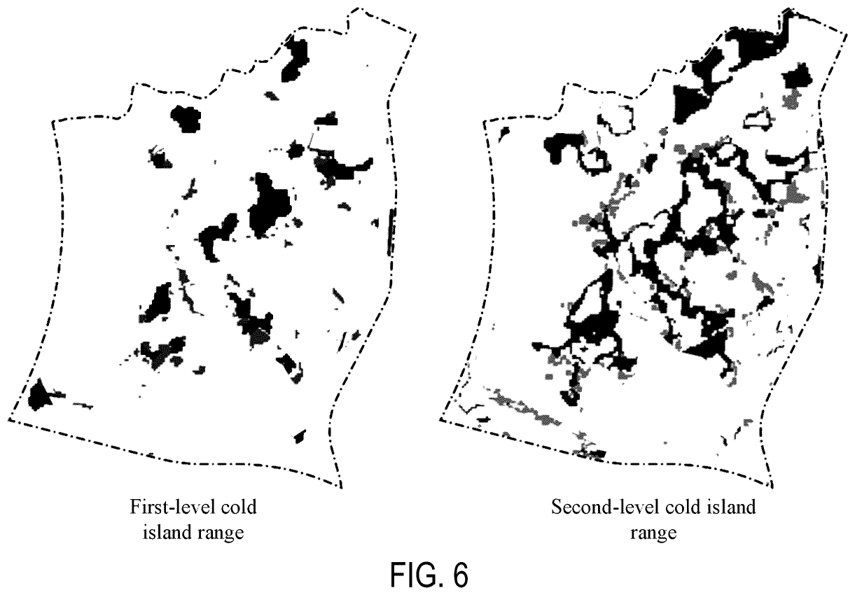

D, as illustrated in FIG. 5, the cold island value evaluation is performed on the vegetation patches and the water body patches located outside the rigid protection range by applying the technology roadmap of the cold island value evaluation based on the ENVI platform to obtain the cold island value grading chart, which is as illustrated in FIG. 6.

D1, the vegetation patches and the water body patches located outside the rigid protection range are superimposed on the land surface temperatures, the land surface temperatures at the patch boundaries and the land surface temperatures in the regions within 600 m from the patch boundaries are extracted to draw a broken line graph, and set the acting range breakpoint, and to position the slow-heating range patches of the vegetation and the slow-heating range patches of the water body according to the positions of the breakpoints.

D2, the land surface temperatures at all slow-heating range patch boundaries in the region are extracted based on the land surface temperature image described in Step C1, to calculate and obtain that the average land surface temperature is 28° C., and the average land surface temperature is taken as the distinguish temperature between the cold island and the hot island, acquiring the distribution chart of the cold and heat island ranges in the region.

D3, the land surface temperatures of the vegetation cold island range and the water body cold island range are extracted based on the land surface temperature image in Step C1.

D4, the k-means clustering algorithm analysis is performed according to the size of the range, the boundary information and the distribution characteristics of the land surface temperatures based on the land surface temperature of the water body cold island range, and the clustering result is set into three categories, and the water body cold island is divided into the low value region, the medium value region and the high value region on the basis of the value for the average land surface temperature in the range in each of the categories.

D5, the vegetation cold island range is graded by utilizing the mean-standard deviation grading method according to the land surface temperatures in the vegetation cold island range. T denotes the average land surface temperature in the range, when T<24° C., the region is the high value region, when 24° C.≤T≤30° C., the region is the medium value region, and when T≥30° C., the region is the low value region.

D6, the vegetation cold island rang and the water body cold island rang in different value regions described in Step D5 are processed by the GIS to obtain the cold island value grading chart. The first-level cold island range is the superposition of the water bodies and the vegetation included in the high-value region, the second-level cold island range is the superposition of the water bodies and the vegetation included in the medium value range.

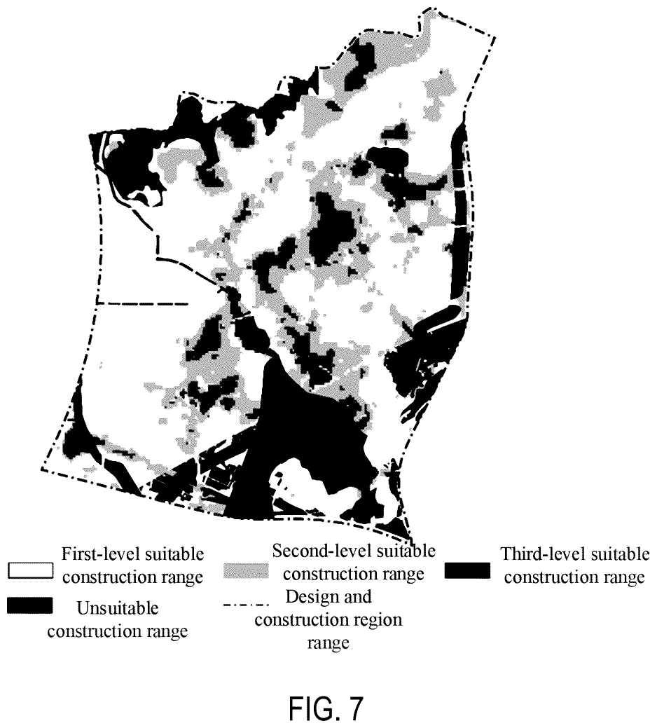

E, the basic suitable construction range obtained in Step B is further graded according to the cold island value grading chart. The design range lines of the first-level cold island range chart and the second-level cold island range chart obtained in Step Dare overlapped in the same proportion with the design range line of the basic construction-suitable range chart obtained in Step B on the same plane, the basic suitable construction range is further divided into the first-level suitable construction range, the second-level suitable construction range, and the third-level suitable construction range after processing by the GIS platform to obtain the suitable construction range grading chart, as illustrated in FIG. 7, which is specifically as follows.

The first-level suitable construction range is the difference set between the basic suitable construction range and the first-level as well as second-level cold island ranges.

The second-level suitable construction range is the intersection of the basic suitable construction range and the second-level cold island range.

The third-level construction-suitable range is the intersection of the basic suitable construction range and the first-level cold island range.

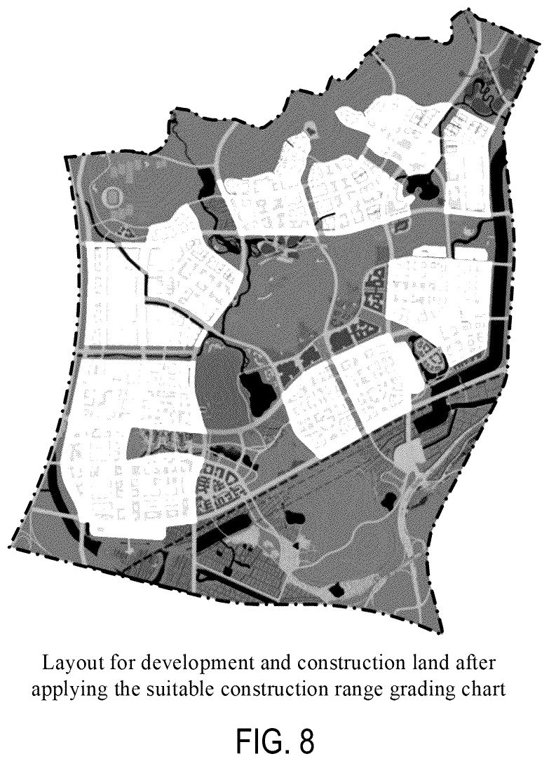

F, the suitable construction range grading chart is outputted. The suitable construction range grading chart is a vector file, which is utilized as the basis of the layout of the development and construction land or utilized to enter the planning and control program. Specifically, the construction land with a floor area ratio greater than 0.8 is preferentially allocated within the first-level suitable construction region, and when the total amount of the construction land in the first-level suitable construction region is insufficient, then the construction land with a floor area ratio greater than 0.8 is selected to be allocated within the second-level suitable construction range, and when the total amount of the construction land in the second-level suitable construction region is still insufficient, then the construction land with a floor area ratio greater than 0.8 is selected to be allocated within the third-level suitable construction range, which is as illustrated in FIG. 8.

1. A method for grading a suitable construction range based on a cold island value evaluation, comprising following steps:
Step 1, acquiring relevant data for natural ecological elements within a research range, and determining a rigid protection range;
Step 2, summarizing a rigid protection range chart library, and superposing, based on a GIS, all rigid protection range charts to obtain a basic suitable construction range chart;
Step 3, acquiring, based on an ENVI platform and an AutoCAD platform, vegetation patches and water body patches located outside the rigid protection range;
Step 4, performing, based on the ENVI platform, the cold island value evaluation on the vegetation patches and the water body patches located outside the rigid protection range to obtain a cold island value grading chart;
Step 5, further grading, according to the cold island value grading chart, the basic suitable construction range chart obtained in Step 2 to obtain a suitable construction range grading chart including a first-level suitable construction range, a second-level suitable construction range and a third-level suitable construction range; and
Step 6, applying the suitable construction range grading chart in a planning and designing, wherein a construction land with a floor area ratio greater than 0.8 is preferentially allocated within the first-level suitable construction range, when a total amount of the construction land in the first-level suitable construction range is insufficient, then the construction land with the floor area ratio greater than 0.8 is selected to be allocated within the second-level suitable construction range, and when a total amount of the construction land in the second-level suitable construction range is still insufficient, then the construction land with the floor area ratio greater than 0.8 is selected to be allocated within the third-level suitable construction range.

2. The method for grading the suitable construction range based on the cold island value evaluation according to claim 1, wherein in the Step 1, the relevant data for the natural ecological elements are AutoCAD vector terrain files, satellite image files and statutory planning documents in the research range.

3. The method for grading the suitable construction range based on the cold island value evaluation according to claim 1, wherein in the Step 1, the rigid protection range is a protection content explicitly stated in the statutory planning documents, including ecological management control regions at all levels, and graded reservoirs or river courses.

4. The method for grading the suitable construction range based on the cold island value evaluation according to claim 1, wherein the Step 2 specifically includes:
performing, through GIS platform, an image process on data for the rigid protection range to summarize and obtain the rigid protection range chart library, and display an area surrounded by clear closed boundary lines; and
superposing all rigid protection rang charts to form an unsuitable construction range, wherein remaining parts within the research range is the suitable construction range, forming the basic suitable construction range chart.

5. The method for grading the suitable construction range based on the cold island value evaluation according to claim 1, wherein the Step 3 specifically includes following sub-steps:
Step 3-1: acquiring a Landsat8 satellite image corresponding to a research city, obtaining a LST file of a land surface temperature and a normalized difference vegetation index, and generating a land surface temperature image; and
Step 3-2: selecting a region with a value for the normalized difference vegetation index in a remote sensing image processing platform software of ENVI to obtain the vegetation patches, wherein a value for the normalized difference vegetation index ranges from 0.48 to 1; obtaining the water body patches according to the relevant data for the natural ecological elements; respectively intersecting the vegetation patches and the water body patches with the basic suitable construction range chart in Step 2 to form the vegetation patches and the water body patches located outside the rigid protection range.

6. The method for grading the suitable construction range based on the cold island value evaluation according to claim 1, wherein the Step S4 specifically includes following sub-steps:
Step 4-1: superposing the vegetation patches and the water body patches located outside the rigid protection range on the land surface temperature image, extracting the land surface temperatures at the patch boundaries and the land surface temperatures in the regions within 600 m from the patch boundaries, drawing a line outward every 30 m with the patch boundary as a center, calculating an average temperature of each of the lines and drawing a broken line graph of temperature various, wherein a breakpoint in the broken line graph with a slop closet to 0 and closet to the patch boundary is set as an acting range breakpoint, and a line where the breakpoint is located is a slow-heating range patch of the vegetation and a slow-heating range patch of the water body;
Step 4-2: extracting, based on the land surface temperature image in the Step 3, the land surface temperatures at all slow-heating range patch boundaries within a region; calculating and obtaining an average temperature of a corresponding slow-heating range patch; taking the average temperature of the slow-heating range patch boundary as a temperature distinguishing the cold and heat islands, to obtain a distribution chart of the cold and heat island ranges in the region;
Step 4-3: extracting, based on the land surface temperature image in the Step 3, land surface temperatures in vegetation and water body cold island ranges;
Step 4-4: calculating, based on the land surface temperature within the water body cold island range, an average land surface temperature in each of the water body cold island ranges; performing, by utilizing an Euclidean distance measurement formula, a k-means clustering according to an area of the water body cold island range and the average land surface temperature of the water body cold island range, and setting a clustering result into three categories, and dividing, on a basis of a value for the average land surface temperature in the region in each of the categories, the water body cold island into three value regions of a low value region, a medium value region and a high value region;
Step 4-5: correspondingly dividing, by utilizing a mean-standard deviation grading method, the vegetation cold island into three value regions of a high value region, a medium value region and a low value region based on the land surface temperature in the vegetation cold island range, wherein T denotes the average land surface temperature in the region;

| Category | Grading Method |
|---|---|
| Mean temperature | μ |
| Standard deviation of temperature | std |
| variation | |
| High value region | T < μ −2std |
| Medium value region | μ −2std ≤ T ≤ μ +2std |
| Low value region | T > μ +2std |

Step 4-6: dividing, according to the cold island value evaluations of the vegetation and water body, a first-level cold island range and a second-level cold island range to obtain a cold island value grading chart;
wherein the first-level cold island range is a superposition of the water bodies and the vegetation included in the high value region, and the second-level cold island range is a superposition of the water bodies and the vegetation included in the medium value region.

7. The method for grading the suitable construction range based on the cold island value evaluation according to claim 1, wherein the Step 5 specifically includes:
superposing the cold island value grading chart obtained in the Step 4 on the basic suitable construction range chart obtained in the Step 2, further decomposing, after processing by the GIS platform, the basic suitable construction range into a first-level suitable construction range, a second-level suitable construction range and a third-level suitable construction range to obtain the suitable construction grading chart;
wherein the first-level suitable construction range is a difference set between the basic suitable construction range and the first-level and the second-level cold island ranges;
the second-level suitable construction range is an intersection between the basic suitable construction range and the second-level cold island range; and
the third-level suitable construction range is an intersection between the basic suitable construction range and the first-level cold island range.

8. The method for grading the suitable construction range based on the cold island value evaluation according to claim 1, wherein the suitable construction range grading chart described in the Step 5 is a vector file utilized as a basis of a layout of a development and construction land or utilized to enter a planning and control program.
